(19) United States
(12) Patent Application Publication
(10) Pub. No.: US 2008/0133722 A1
(43) Pub. Date: Jun. 5, 2008

(54) PARALLEL DYNAMIC WEB PAGE SECTION PROCESSING

(75) Inventors: Sethuraman Ramasundaram, Bangalore (IN); Srinivas Padmanabhuni, Bangalore (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 11/949,698

(22) Filed: Dec. 3, 2007

(30) Foreign Application Priority Data
Dec. 4, 2006 (IN) 2245/CHE/2006

(51) Int. Cl. G06F 15/177

(52) U.S. Cl. 709/222

(57) ABSTRACT

Dynamic sections of a web page having dynamic content can be processed and received in parallel. Display of the dynamic sections can proceed in parallel. A script mechanism can be transmitted to a client, which executes the script to create a connection and receive dynamic content from a server independently for separate sections. An identifier can be used to differentiate between different sections on the web page.

### BACKGROUND

Dynamically generated web content is becoming more pervasive on web sites, especially e-commerce sites. For example, a web site providing services to bank customers can generate web pages that contain information from databases or other data sources. One popular way of generating dynamic content is through a mechanism called “JavaServer Pages” (JSP) based on technology developed by Sun Microsystems.

JavaServer Pages allow a web developer to specify a web page that contains both static and dynamic content. The dynamic content can be specified as Java software code. Such code can perform a variety of processing and return dynamic content in the form of HTML, which is eventually rendered as displayed content in a web browser. JavaServer Pages can also support programming-like features such as include tags.

FIG. 1 is a prior art method 100 of processing a JavaServer Page (JSP). At 110, a request is received for a web page that is represented at the web site as a JavaServer Page. At 120, static HTML is read according to the JavaServer Page. At 130, dynamic HTML is generated (e.g., via a database) according to code in the JavaServer Page. At 140, more dynamic HTML is generated (e.g., via a database) according to more code in the JavaServer Page. Finally, at 150, the HTML is sent to the client, for display in a browser.

Although the arrangement of FIG. 1 provides useful features, the total time to process the page is the sum total of the times to process each code section in the JavaServer Page.

FIG. 2 is a prior art method 200 of processing a JavaServer Page that processes dynamic sections in parallel. At 210, a request is received for a web page that is represented at the server as a JavaServer Page. At 220, static HTML is read according to the JavaServer Page. At 230, dynamic HTML is generated according to code in the JavaServer Page. At 240, more dynamic HTML is generated according to more code in the JavaServer Page. However, 220, 230, and 240 are performed in parallel. At 250, the response is assembled at the server, and at 260, the HTML is sent to the client, for display on a browser. The arrangement of FIG. 2 thus can provide superior performance in terms of total time to process the page. The content is streamed sequentially to the browser, and the browser reads and renders it sequentially. A tag can be provided to designate independent sections of the JavaServer page to be executed in parallel threads at the server side.

While present technologies do provide useful features, there remains room for improvement in the processing of JavaServer Pages or other technologies related to generating dynamic HTML content.

### SUMMARY

A variety of techniques can be used for parallel processing of dynamic sections of web pages. As described herein, content for plural dynamic sections of a web page based on a web page template can be streamed in parallel. Also, content for plural dynamic sections of a web page based on a web page template can be displayed in parallel.

As described herein, a variety of other features and advantages can be incorporated into the technologies as desired.

Although the technologies can be applied to e-commerce sites, they can also be applied to a wide variety of other scenarios, such as any web site involving dynamic content.

The foregoing and other features and advantages will become more apparent from the following detailed description of disclosed embodiments, which proceeds with reference to the accompanying drawings.

### BRIEF DESCRIPTION OF THE FIGURES

FIG. 1 is a prior art method of processing a JavaServer Page.

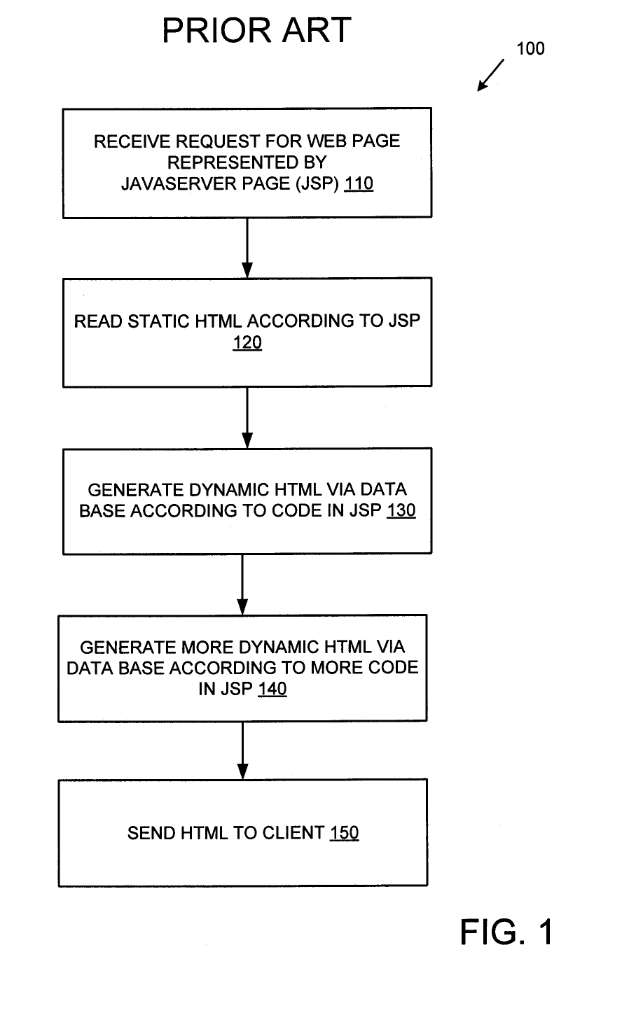

FIG. 2 is a prior art method of processing a JavaServer Page that processes dynamic sections in parallel.

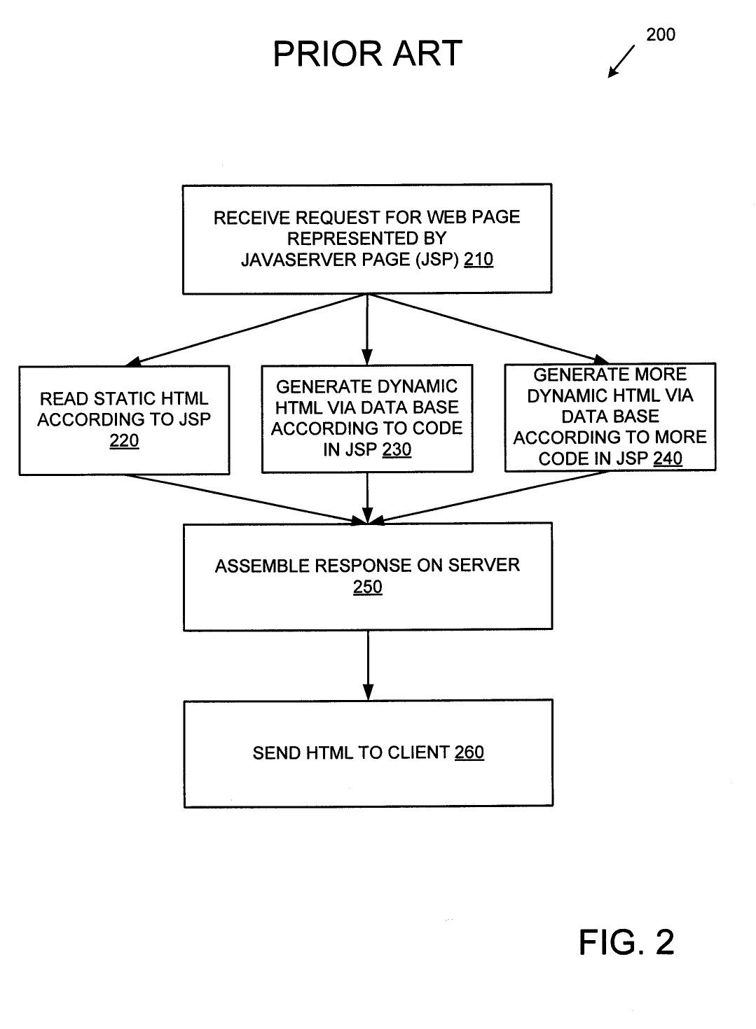

FIG. 3 is a block diagram of an exemplary system for processing plural dynamic sections of a web page in parallel.

FIG. 4 is a flowchart of an exemplary method of processing a web page template via sending dynamic content as requested by a client and can be implemented in a system such as that shown in FIG. 3.

FIG. 5 is a flowchart of an exemplary method of streaming independent dynamic sections of a web page in parallel.

FIG. 6 is a flowchart of an exemplary method of displaying independent dynamic sections of a web page in parallel.

FIG. 7 is a block diagram of an exemplary system by which a script can receive dynamic content from a web server for inclusion as a dynamic section in a web page.

FIG. 8 is a flowchart of an exemplary method at a server of sending dynamic content of a web page via connections from scripts embedded in a web page.

FIG. 9 is a flowchart of an exemplary method at a client for receiving dynamic content for placeholders via connections to dynamic content generators at a server.

FIG. 10 shows an exemplary connection scheme for parallel processing of dynamic sections of a web page.

FIG. 11 is a flowchart of an exemplary method at a server of sending dynamic content of a web page based on a web page template in parallel.

FIG. 12 is a flowchart of an exemplary method at a client for receiving dynamic content of a web page based on a web page template in parallel.

FIG. 13 is a block diagram of an exemplary system using JavaServer Pages and client-side JavaScript scripts for streaming dynamic content sections in parallel to a client.

FIG. 14 is a flowchart of an exemplary method using JavaServer Pages and client-side executing JavaScript scripts for streaming dynamic content in parallel to a client.

FIG. 15 is a block diagram of an exemplary suitable computing environment for implementing any of the technologies described herein.

### DETAILED DESCRIPTION

### EXAMPLE 1

### Exemplary System Employing A Combination of the Technologies

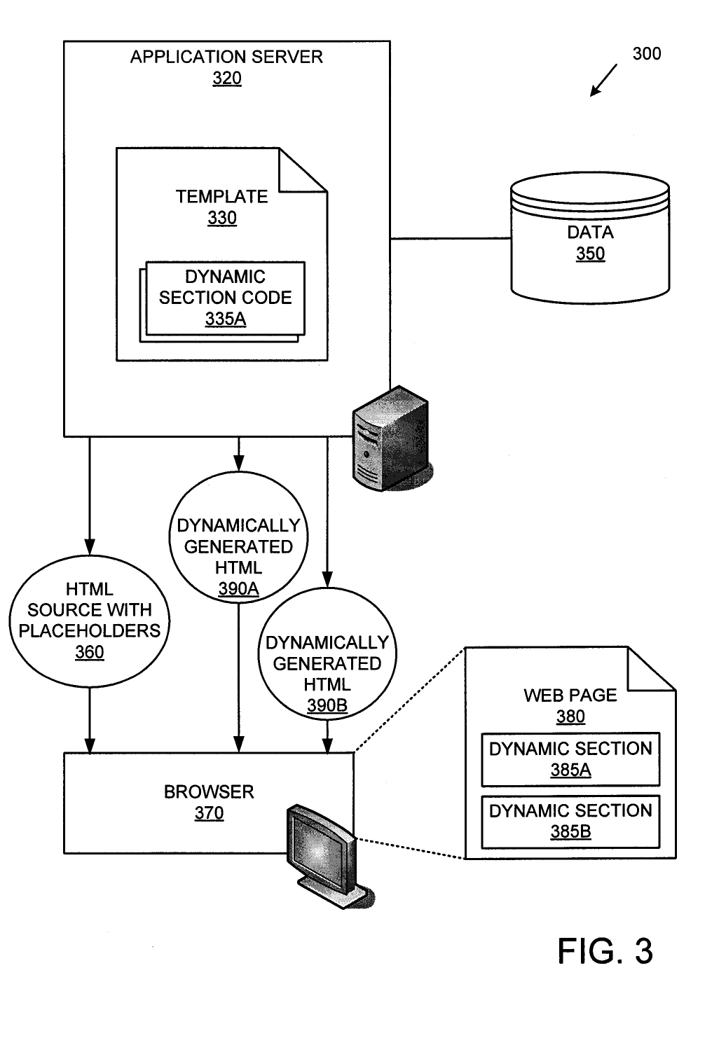

FIG. 3 is a block diagram of an exemplary system 300 for processing web page templates that include dynamic content, in which plural dynamic sections of a web page based on a web page template can be processed in parallel. The system 300 and variants of it can be used to perform any of the methods described herein.

In the example, a web server receives requests for web pages via a network from a browser 370 (sometimes called a “client”). A web page can be represented by a template 330 that can include a mechanism for specifying static HTML as well as a mechanism for embedding a plurality of mechanisms for generating dynamic content (e.g., dynamic section code 335A) in the template. The template 330 can be processed by an application server 320, which can host code that generates dynamic content. When executed, the mechanisms for generating dynamic content can draw on a variety of sources, such as the data base 350 to generate dynamic content (e.g., dynamically generated HTML).

In any of the examples herein, the mechanisms for generating dynamic content can execute in parallel. For example, the mechanisms for generating dynamic content can be run on different threads.

In the example, the application server 320 can process the template 330 and send out HTML source 360 with placeholders for the dynamic sections (e.g., without the actual dynamic content embedded therein). The browser 370 can render the web page 380, including the dynamic sections 385A and 385B, which can be empty (e.g., before the dynamic content is received).

Independent streams 390A and 390B of dynamically generated HTML for the dynamic sections can be streamed in parallel (e.g., as they become available from the dynamic content generators executing as a result of the mechanisms for generating dynamic content).

The independent sections 385A and 385B can be displayed in parallel in the browser (e.g., they can be filled with dynamic content in parallel).

In practice, the system 300 can be more complicated, with additional functionality, more dynamic sections, additional data sources, and the like.

### EXAMPLE 2

### Exemplary Perspectives

Although some of the examples assume the perspective of the server 320, the methods described herein can be implemented from other perspectives (e.g., from the perspective of a browser or a client machine). For example, although the terminology “sending dynamic HTML” can be used from the perspective of the server 320, such an act could also be described as “receiving dynamic HTML” from the perspective of a browser 370.

### EXAMPLE 3

### Exemplary Method Employing A Combination of the Technologies

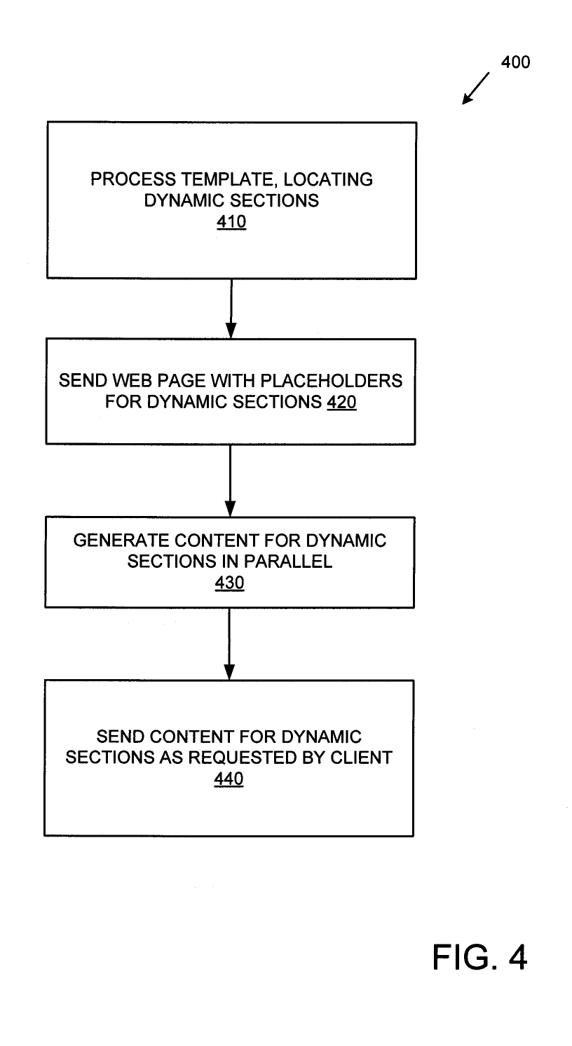

FIG. 4 is a flowchart of an exemplary method 400 of processing a web page template via sending dynamic content as requested by a client and can be implemented in a system such as that shown in FIG. 3.

At 410, the template is processed, locating dynamic sections within the template (e.g., where dynamic content generation mechanisms are found in the template).

At 420, the web page is sent to a client with placeholders for the dynamic sections (e.g., the actual content for the dynamic sections is missing).

At 430, the content for the dynamic sections is generated in parallel. For example, plural dynamic content generators can generate the dynamic content for the dynamic sections in parallel.

At 440, the content for the dynamic sections is sent as requested by the client. For example, the client can request the sections, and the content can be sent as it becomes available (e.g., from the dynamic content generators).

The method 400 and any of the methods described herein can be performed by computer-executable instructions stored in one or more computer-readable media (e.g., storage or other tangible media).

### EXAMPLE 4

### Exemplary Method Employing A Combination of the Technologies

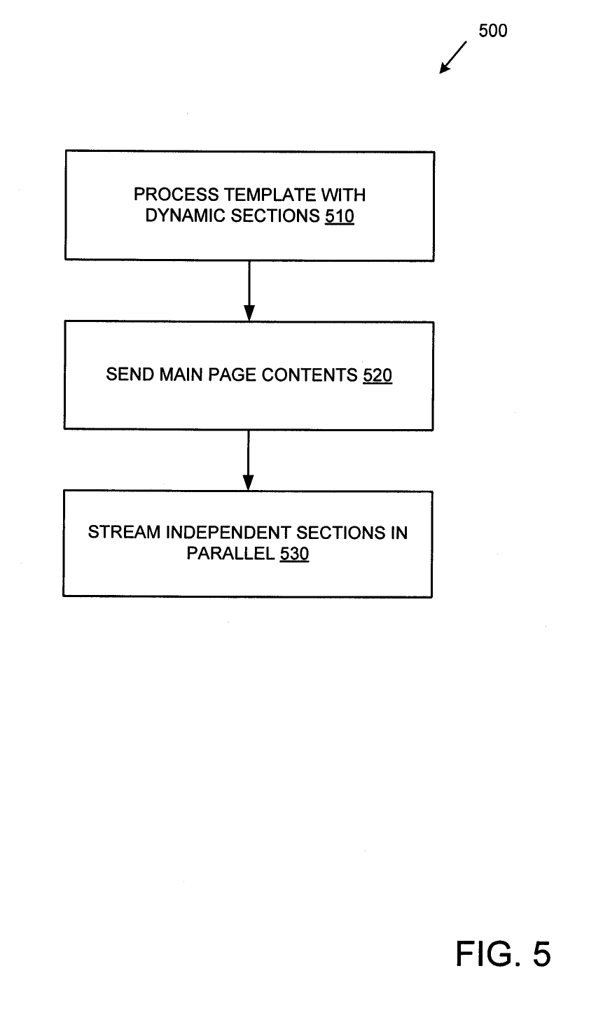

FIG. 5 is a flowchart of an exemplary method 500 of streaming independent dynamic sections of a web page generated from a server-side template in parallel and can be implemented in a system such as that shown in FIG. 3. The actions shown can be performed server side.

At 510, a web page template with dynamic sections is processed. Processing can include parallel processing for generating the dynamic content of the dynamic sections.

At 520, the main web page contents are sent from the server to the client. As described herein, placeholders can be used for dynamic sections, which do not actually contain the dynamic content when sent to the server.

At 530, the dynamic sections are independently streamed in parallel from the server to the client.

### EXAMPLE 5

### Exemplary Method Employing A Combination of the Technologies

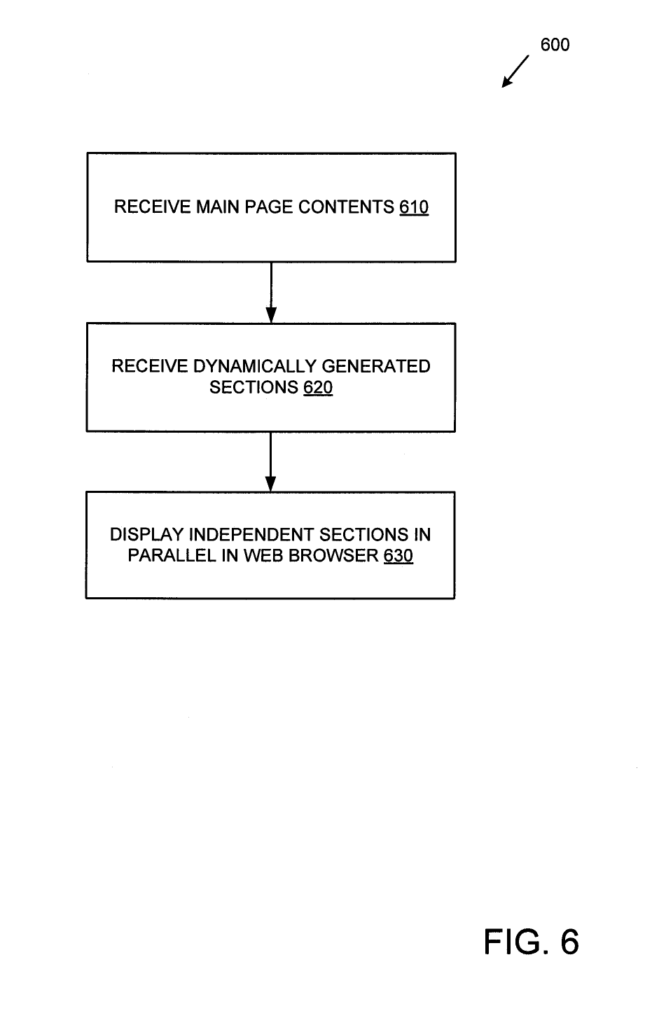

FIG. 6 is a flowchart of an exemplary method 600 of displaying independent dynamic sections of a web page generated from a server-side template in parallel and can be implemented in a system such as that shown in FIG. 3. The actions shown can be performed client side.

Although not shown, the actions can be started by requesting a web page (e.g., via an URL) from a server.

At 610, the contents of the main web page is received. As described herein, the main web page can include placeholders for dynamic sections.

At 620, dynamic content for the dynamically generated sections can be received from the server.

At 630, the dynamic content for the dynamic sections is independently displayed in parallel in the web browser (e.g., as part of a web page). The content for the main web page and the dynamic content for the dynamic sections can be displayed in a single web page at the client.

### EXAMPLE 6

### Exemplary Application Server

In any of the examples herein, a web server or server can be any mechanism configured to fulfill web page requests. In practice, a web server may in fact be composed of a plurality of computers (e.g., in a web farm or load balancing arrangement).

The server can include technology for processing web page templates, such as an application server. For example, a web server can pass specialized requests to the application server for processing. Such an application server can include a facility for providing a Servlet Container for JavaServer Pages, or a similar mechanism for other technologies (e.g., MICROSOFT Active Server Pages or the like). Although an application can provide additional functionality (e.g., for Enterprise JavaBeans), the technologies herein can be implemented without such functionality if desired.

### EXAMPLE 7

### Exemplary Static Web Page Content

In any of the examples herein, static web page content can be content that does not change between viewings of the web page (e.g., the content is the same). Such content is sometimes called “hard coded” content because it does not depend on software programs to generate it. Examples of such content include HTML specifying a company name and logo, hyperlinks to “About Us,” and the like.

Static web page content can be hard coded into a template, or the static content can be specified by indicating a location (e.g., file name) at which the content can be found (e.g., via a conventional include tag). In this way, static content (e.g., address of a company) can be replicated throughout the web site without having to place it within multiple pages of a web site.

### EXAMPLE 8

### Exemplary Dynamic Web Page Content

In any of the examples herein, dynamic web page content can be content that changes depending on various conditions (e.g., generated by a program that draws on data sources such as databases and the like). Examples of such content include bank balances, prices, customer names, and the like.

### EXAMPLE 9

### Exemplary Dynamic Sections

In any of the examples herein, dynamic sections of a web page template can be used to designate the corresponding dynamic sections of the resulting web page. A special tag can be used to indicate which sections are to be processed in parallel.

In practice, it is possible that one or more dynamic sections are not desired to be processed in parallel. So, not all dynamic sections need to be included in parallel processing. The dynamic section can specify a dynamic content generator, or a location at which a dynamic content generator resides (e.g., a file name of a program or another template referencing or having a program, such as Java code), for generating the dynamic section.

### EXAMPLE 10

### Exemplary Technologies Supporting Embedding Dynamic Web Page Content in Static Web Page Content

In any of the examples herein, any technology that supports a web page template that allows embedding dynamic web page content within static web page content can be used. Such technologies include JavaServer Pages (JSP), Active Server Pages (ASP), and the like.

In any of the examples herein, the web page can be based on such a web page template. The template can be processed with a template engine, which can coordinate execution of the code for generating dynamic web page content (e.g., on an application server).

### EXAMPLE 11

### Exemplary Tag

In any of the examples herein, a tag mechanism can be used to denote which sections in a template are to be processed in parallel. During processing of the template, responsive to encountering the tag, the section can be processed in parallel, such as on different threads (e.g., created responsive to encountering the tag); streamed in parallel; displayed in parallel; or any combination thereof. Thus, encountering the tag can trigger parallel processing, parallel streaming, parallel display, or combinations thereof.

The tag can go beyond a simple one word tag to include a simple syntax, such as an initial keyword indicating that parallel processing is involved and a qualifying keyword that clarifies where the tag is specifying where a group of sections (e.g., a page) begins or where a dynamic section begins (or the name of a location where the dynamic section or a dynamic content generation mechanism can be found).

For example, the JavaServer Pages tag mechanism can be used to denote which sections in a template are to be processed in parallel. A special tag name can be used in the tag.

A tag mechanism for processing tags in a tag library can already be present in the template engine. A special (e.g., denoting parallel processing, streaming, display, or combination thereof) tag can be added as an extension to an existing tag library.

### EXAMPLE 12

### Exemplary Dynamic Content Generator

In any of the examples herein, a dynamic content generator can be any mechanism that is configured to generate dynamic web page content (e.g., HTML). Java code or other programming languages can be used. In practice, the code can be compiled to an executable form before generating output.

### EXAMPLE 13

### Exemplary Main Web Page

In any of the examples herein, a main web page can be utilized. Such a page can include placeholders for dynamic content in a dynamic section of the web page in lieu of the actual content for the respective dynamic section.

### EXAMPLE 14

### Exemplary Placeholders

In any of the examples herein, a placeholder can be used to denote a location (e.g. a section) at which dynamic content is to be placed when it is received. The placeholder can include a scripting mechanism that retrieves the dynamic content (e.g., asynchronously in parallel with other executing scripting mechanisms) when the scripting mechanism executes on the client. A section identifier can be included that uniquely identifies the section on the web page (e.g., so that dynamic sections can be distinguished when a request is received at the server).

### EXAMPLE 15

### Exemplary System With Executing Client-Side Script

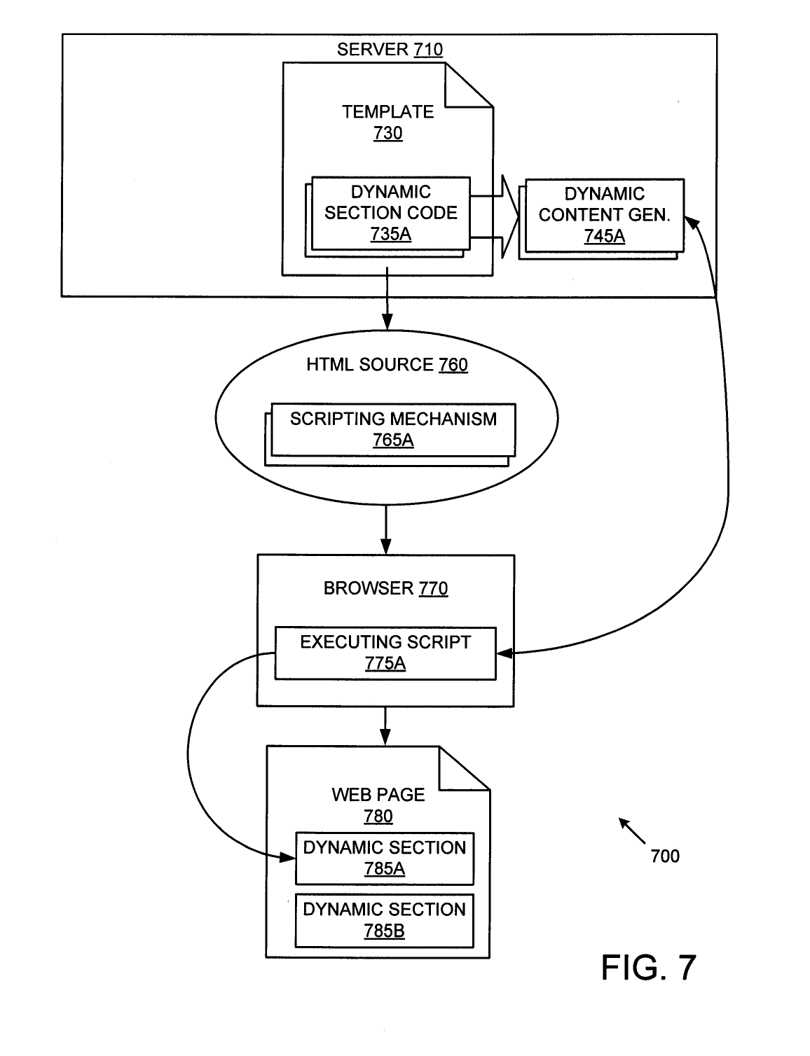

FIG. 7 is a block diagram of an exemplary system 700 by which a script can receive dynamic content from a server for inclusion as a dynamic section in a web page.

In the example, a server 710 (e.g., an application server) includes a mechanism for processing a web page template 730 that includes a plurality of sections of dynamic section code 735A. For example, tags can be used in the template 730 to indicate the dynamic sections.

When the template 730 is processed, a plurality of dynamic content generators 745A can execute in parallel to generate the dynamic content of the web page.

Meanwhile, the HTML source 760 can be generated via the template 730 before the dynamic content generators 745A have finished generating content. Included in the HTML source 760 are scripting mechanisms 765A corresponding to the dynamic sections of the template 730. The actual dynamic content need not be present.

The browser 770 can use the scripting mechanism 765A, by which a plurality of scripts 775A can be executed in parallel to retrieve the dynamic content from the respective dynamic content generators 745A and place the content in the dynamic section (e.g., 785A) of the web page 780 when rendered. Other dynamic sections (e.g., 785B) can be handled similarly, leading to display of the sections in parallel by the browser 770.

As described herein, section identifiers can be included in the HTML source 760, by which requests for dynamic content can be distinguished at the server 710.

### EXAMPLE 16

### Exemplary Server-Side Method of Sending Scripts To Client

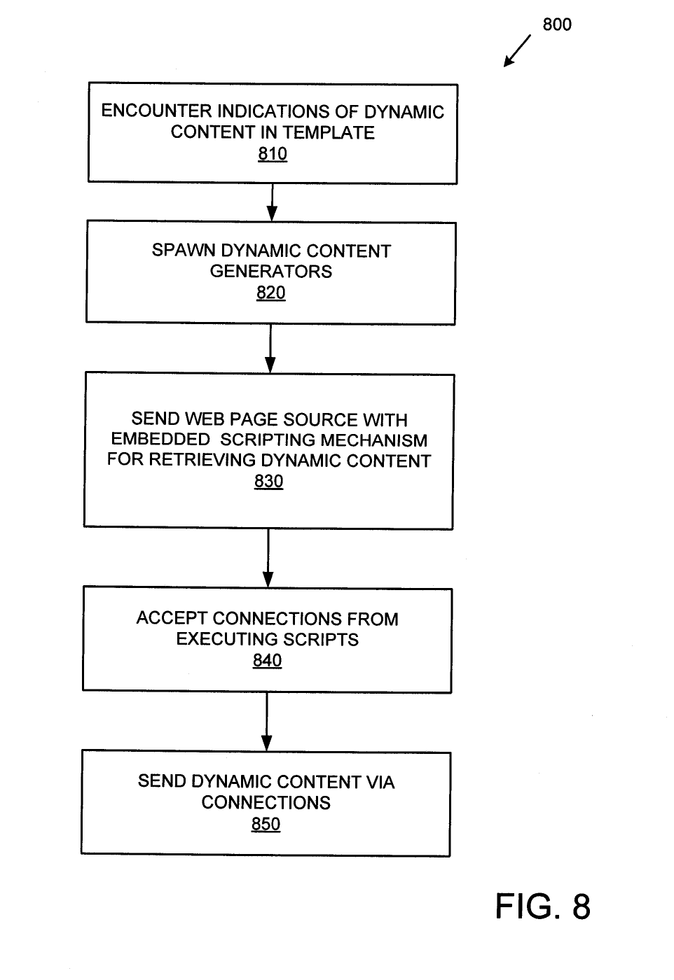

FIG. 8 is a flowchart of an exemplary method 800 of sending dynamic content of a web page via connections from scripts embedded in a web page and can be implemented in a system such as that shown in FIG. 7. The actions can be performed server side.

At 810, when processing the web page template, an indication of dynamic content is encountered in the template. For example, a special tag can be used to denote the sections that are to be processed in parallel by the technology.

At 820, dynamic content generators are spawned and run in parallel for respective dynamic sections of the template.

At 830, the web page source with embedded scripting mechanisms for retrieving the dynamic content is sent to the client.

At 840, connections from the scripts (e.g., now executing at the client) are accepted by or on behalf of the dynamic content generators. Such scripts can be implemented using asynchronous execution technology so that the scripts execute asynchronously.

At 850, the dynamic content is sent from the dynamic content generators to the client (e.g., via the scripts) via the connections.

### EXAMPLE 17

### Exemplary Client-Side Method of Receiving Dynamic Content for Placeholders

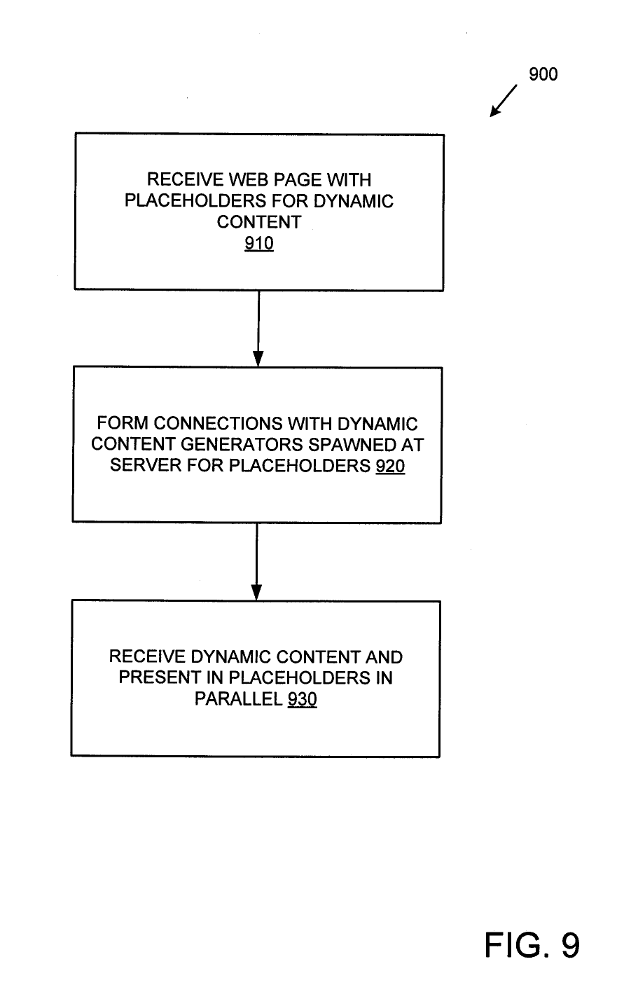

FIG. 9 is a flowchart of an exemplary method 900 of receiving dynamic content for placeholders via connections to dynamic content generators at a server and can be implemented in a system such as that shown in FIG. 7. The actions can be performed client side.

At 910, a web page (e.g., a main web page) with placeholders for dynamic content is received.

At 920, connections with dynamic content generators spawned at the server for respective placeholders are formed.

At 930, dynamic content is received and presented in respective placeholders in parallel.

### EXAMPLE 18

### Exemplary Connection Scheme

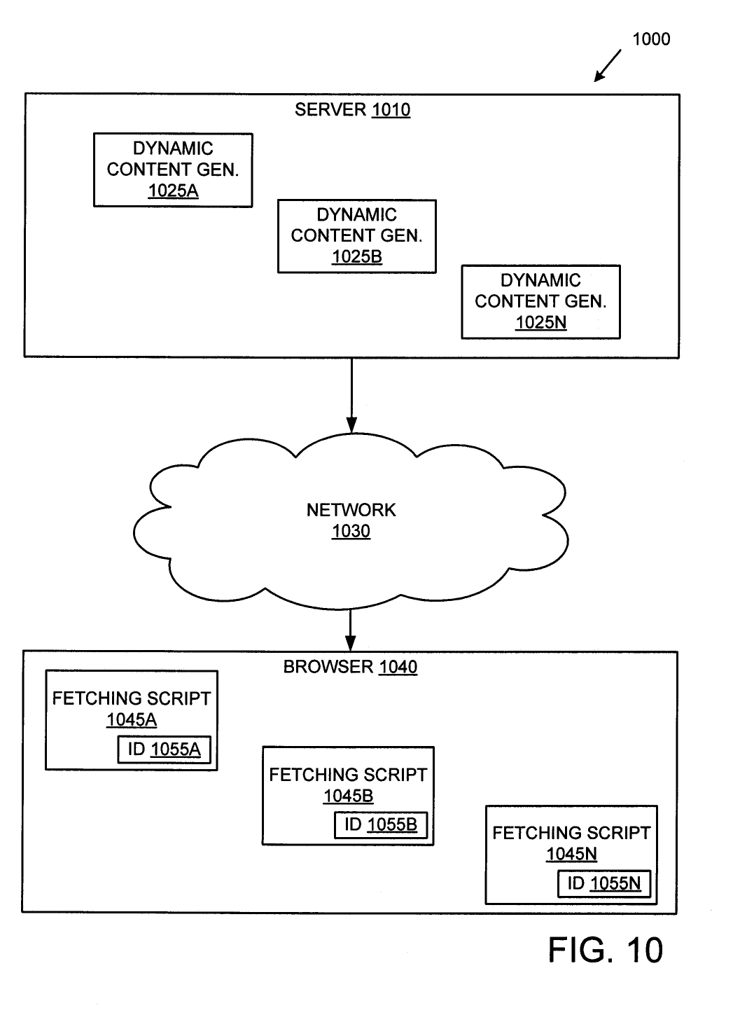

FIG. 10 shows an exemplary connection scheme 1000 for parallel processing of dynamic sections of a web page. In the example, a server 1010 and a client browser 1040 communicate via a network 1030 (e.g., the Internet, and intranet, an extranet, or the like).

A plurality of dynamic content generators 1025A-N execute at the server 1010. On the client, a plurality of fetching scripts 1045A-N execute. As shown, a fetching script 1045A-N can have a respective section identifier 1055A-N, by which dynamic sections within the web page can be differentiated.

The content generators 1025A-N and fetching scripts 1045A-N can work in concert to achieve the parallel streaming, parallel display, or both, as described herein.

Independent streaming (e.g., by separate scripts, connections, or both) can be used to achieve parallel streaming.

### EXAMPLE 19

### Exemplary Server-Side Method of Sending Dynamic Content

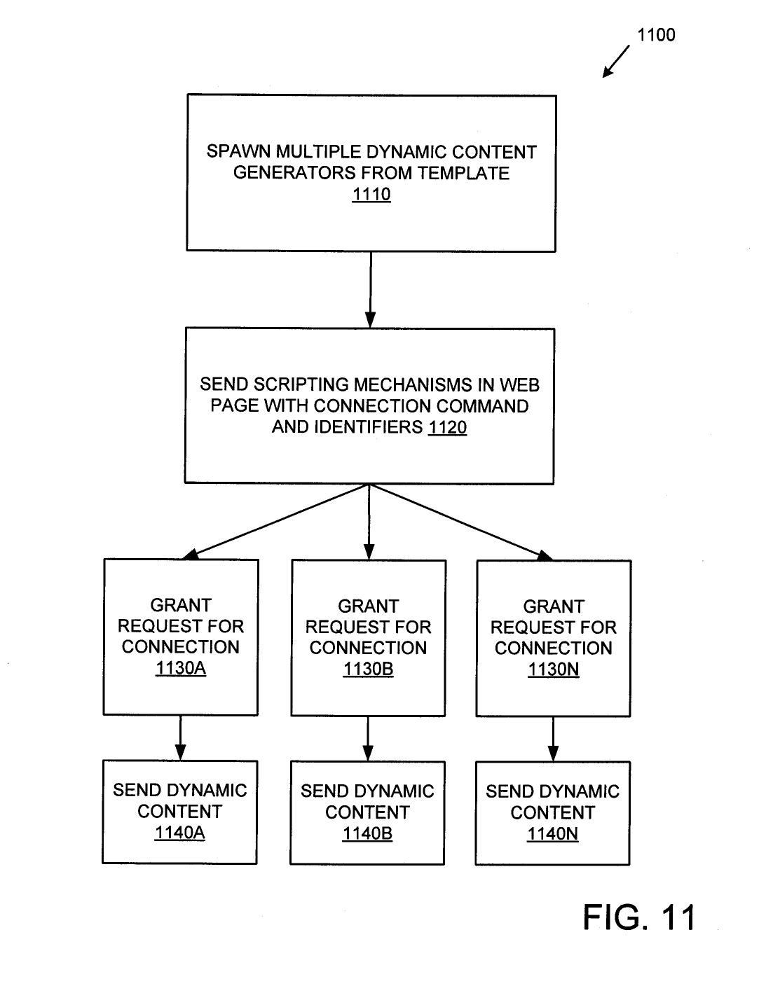

FIG. 11 is a flowchart of an exemplary method 1100 at a server of sending dynamic content sections of a web page based on a web page template in parallel.

At 1110, multiple dynamic content generators are spawned for a web page template.

At 1120, scripting mechanisms with a connection command and section identifiers are sent in a web page to the client.

At 1130A-N, requests for connections are granted in parallel, and at 1140A-N, the dynamic content is sent in parallel (e.g., streamed) from the server to the client.

### EXAMPLE 20

### Exemplary Client-Side Method of Receiving Dynamic Content

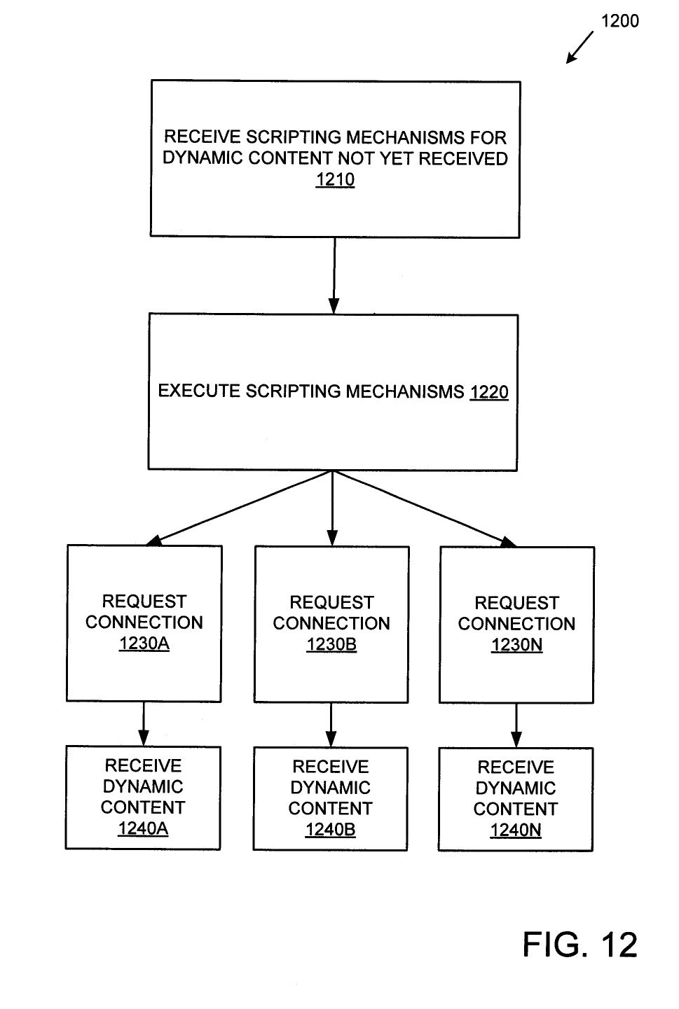

FIG. 12 is a flowchart of an exemplary method 1200 at a client of receiving dynamic content sections of a web page based on a web page template in parallel.

At 1210, scripting mechanisms for retrieving dynamic content not yet received are received as part of a web page.

At 1220, the scripting mechanisms are executed in parallel.

At 1230A-N, connections with the server are requested by the scripting mechanisms in parallel.

At 1240A-N, the dynamic content is received in parallel. Display of the content can also proceed in parallel.

### EXAMPLE 21

### Exemplary Parallel Processing

In any of the examples herein, parallel processing can be used to describe processing that does not proceed sequentially (e.g., a second running job need not wait for a first running job to finish before proceeding). Parallel processing can be performed on hardware having one or more than one processor. Parallel processing does not require that the actions be processed simultaneously.

In the examples herein, a second running dynamic content generator need not wait for a first running job to output its HTML. Further, the dynamic content can proceed to be sent in an order different from that specified in the web page template. Also, the dynamic content can proceed to be displayed in a temporal order different from the sequential order in which it appears in the web page template.

### EXAMPLE 22

### Exemplary Implementation Using JavaServer Pages

In any of the examples herein, the technology can be implemented using JavaServer Pages (JSP) as web page templates. The dynamic content generators can be Java code executing within a servlet container. The dynamic sections can comprise the Java code for generating the dynamic content for a respective dynamic section.

The scripting mechanism can be implemented as JavaScript using AJAX technology to asynchronously move the dynamic content from the server to the client. A special tag in the JavaServer Page can denote dynamic sections that are to be processed in parallel.

### EXAMPLE 23

### Exemplary System Using JavaServer Pages

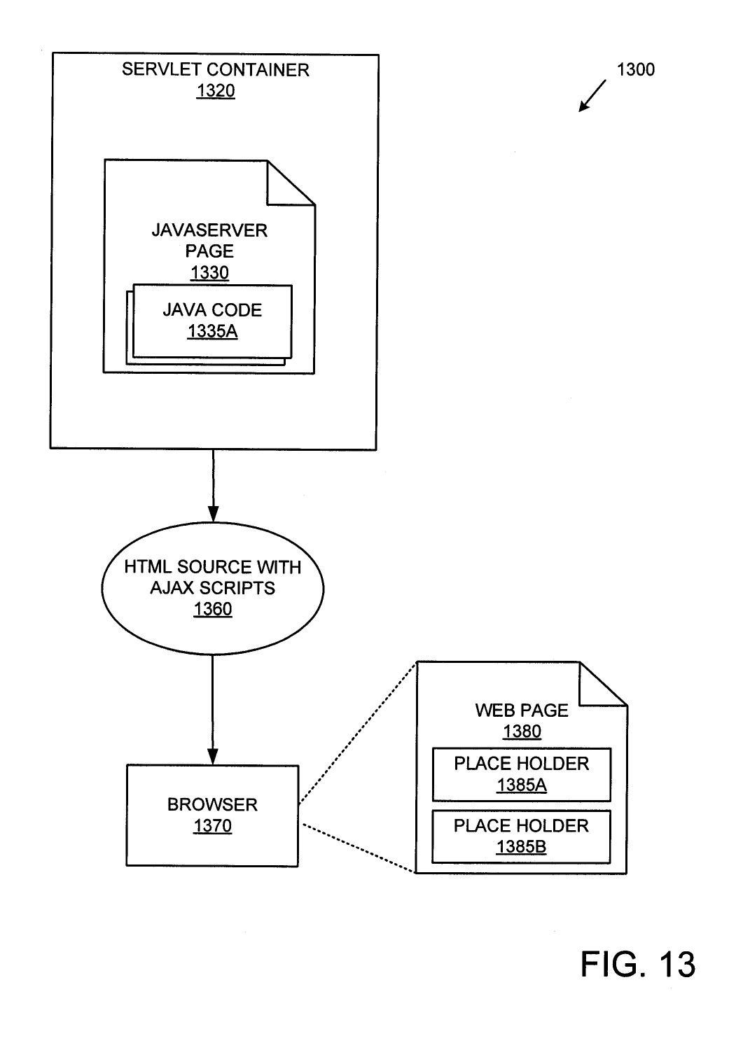

FIG. 13 is a block diagram of an exemplary system 1300 using JavaServer Pages and client-side JavaScript scripts for streaming dynamic content sections in parallel to a client.

In the example, a servlet container 1320 is used to execute Java code 1335A, which can generate dynamic content for the JavaServer Page 1330.

The HTML Source 1360 including the JavaScript scripts that employ AJAX can be sent to the browser 1370, which displays the web page 1380 at the client machine. The placeholders 1385A-B can initially have no dynamic content, but be filled by execution of the JavaScript scripts as described herein.

### EXAMPLE 24

### Exemplary Method Using JavaServer Pages

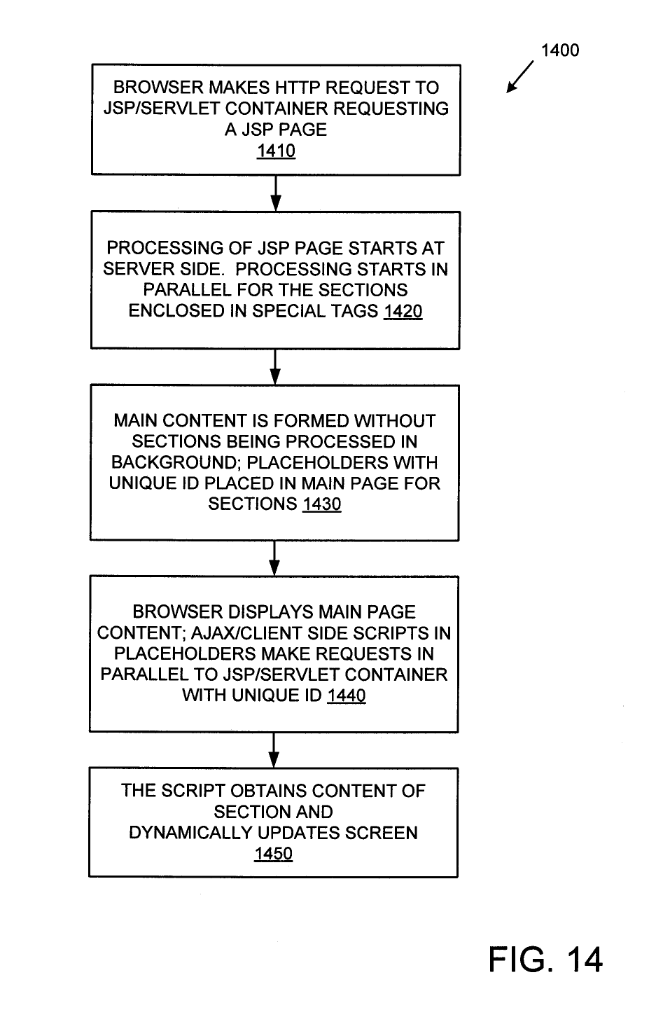

FIG. 14 is a flowchart of an exemplary method 1400 using JavaServer Pages and client-side executing JavaScript scripts using AJAX for streaming dynamic content in parallel to a client.

At 1410, a browser makes a HTTP request to a JSP/servlet container, requesting a JSP page.

At 1420, processing of the JSP page starts at the server side. Processing starts in parallel for the sections enclosed in special tags denoting dynamic sections to be processed in parallel.

At 1430, the content of the main web page is formed without the sections, which are being processed in the background in parallel. Placeholders with a unique identifier are placed in the main page for respective dynamic sections.

At 1440, the browser displays the main page content. AJAX/client side scripts in the placeholders make requests in parallel to the JSP/servlet container with the unique identifier.

At 1450, the script obtains content of the dynamic section and dynamically updates the browser's display.

### EXAMPLE 25

### Exemplary Connection Mechanisms

In any of the examples herein the scripting mechanism can use an XML technique to send the HTML asynchronously. For example, the XML can simply specify the HTML that was generated by the respective dynamic content generator.

### EXAMPLE 26

### Exemplary Features

In any of the examples herein, parallel content streaming can be achieved. The content generated by independent sections that are processed in parallel in the server side can be streamed to the client side in parallel.

Parallel display in a browser can also be achieved. The display of independent sections can happen in parallel in the web browser.

The features can be provided with the help of asynchronous client-side scripting technology such as AJAX.

At development time, a JSP is taken and the independent sections of the page can be taken into separate JSP include files. The files can then be included in the parent JSP using tags provided by parallel-execution JSP technology.

While running the program, the browser makes a HTTP request to a JSP/Servlet container requesting a JSP page.

The processing the JSP page starts at the server side. Processing starts in parallel for the sections of the page enclosed in the parallel-execution tags.

The main page content can be formed without the sections processed by the parallel-execution technology. Only placeholders (e.g., JavaScript with asynchronous calls as in AJAX) are placed in the main page content. The placeholders can include a unique identifier that is associated with the execution that the parallel-execution library is processing in the background.

The browser displays the main page content. Now the AJAX/client-side script code in the section placeholders makes requests in parallel to the JSP/servlet container with the unique id that was generated earlier. The AJAX/client side script gets the content of the respective portion and dynamically updates the screen.

### EXAMPLE 27

### Exemplary Other Features

In any of the examples herein, the technology can provide a way to parallelize execution at the server side combined with a way to load the sections in the browser again in parallel (e.g., using client-side asynchronous invocation mechanisms like AJAX), without waiting for the whole page to be loaded simultaneously, thereby enabling web pages (based on JSPs) that have independent sections to be displayed faster to the end user.

Instead of executing sequentially and sending to the client when the buffer is full (or when the buffer is flushed), the technology can execute sections of a JSP in parallel at the server side and load the sections in parallel inside the browser using a scripting mechanism such as AJAX.

### EXAMPLE 28

### Exemplary Computing Environment

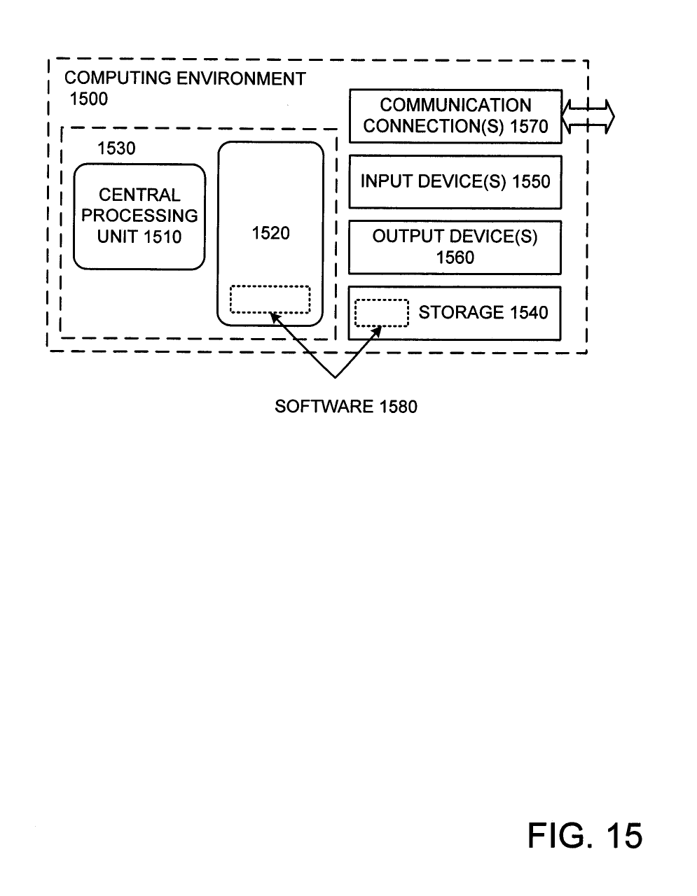

FIG. 15 illustrates a generalized example of a suitable computing environment 1500 in which the described techniques can be implemented. The computing environment 1500 is not intended to suggest any limitation as to scope of use or functionality, as the technologies may be implemented in diverse general-purpose or special-purpose computing environments. A mainframe environment will be different from that shown, but can also implement the technologies and can also have computer-readable media, one or more processors, and the like.

With reference to FIG. 15, the computing environment 1500 includes at least one processing unit 1510 and memory 1520. In FIG. 15, this basic configuration 1530 is included within a dashed line. The processing unit 1510 executes computer-executable instructions and may be a real or a virtual processor. In a multi-processing system, multiple processing units execute computer-executable instructions to increase processing power. The memory 1520 may be volatile memory (e.g., registers, cache, RAM), non-volatile memory (e.g., ROM, EEPROM, flash memory, etc.), or some combination of the two. The memory 1520 can store software 1580 implementing any of the technologies described herein.

A computing environment may have additional features. For example, the computing environment 1500 includes storage 1540, one or more input devices 1550, one or more output devices 1560, and one or more communication connections 1570. An interconnection mechanism (not shown) such as a bus, controller, or network interconnects the components of the computing environment 1500. Typically, operating system software (not shown) provides an operating environment for other software executing in the computing environment 1500, and coordinates activities of the components of the computing environment 1500.

The storage 1540 may be removable or non-removable, and includes magnetic disks, magnetic tapes or cassettes, CD-ROMs, CD-RWs, DVDs, or any other computer-readable media which can be used to store information and which can be accessed within the computing environment 1500. The storage 1540 can store software 1580 containing instructions for any of the technologies described herein.

The input device(s) 1550 may be a touch input device such as a keyboard, mouse, pen, or trackball, a voice input device, a scanning device, or another device that provides input to the computing environment 1500. For audio, the input device(s) 1550 may be a sound card or similar device that accepts audio input in analog or digital form, or a CD-ROM reader that provides audio samples to the computing environment. The output device(s) 1560 may be a display, printer, speaker, CD-writer, or another device that provides output from the computing environment 1500.

The communication connection(s) 1570 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Communication media can embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the above can also be included within the scope of computer readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Methods In Computer-Readable Media

Any of the methods described herein can be implemented by computer-executable instructions in one or more computer-readable media (e.g., computer-readable storage media or other tangible media). The technologies described herein can be implemented in a variety of programming languages.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

We claim:

1. A computer-implemented method of processing a web page template comprising a plurality of dynamic sections, the method comprising:
processing the web page template at a server, wherein the processing comprises locating the dynamic sections within the template;
sending a main web page to a client, wherein the main web page omits content for the dynamic sections within the template; and
for dynamic sections within the template, sending respective independent streams of dynamic content to the client in parallel for display by the client within the main web page.

2. The method of claim 1 further comprising:
displaying content for the main web page and dynamic content for the dynamic sections in a single web page at the client.

3. The method of claim 1 wherein:
the template is a JavaServer page;
dynamic sections within the template indicate Java code configured to generate HTML for the respective dynamic section; and
the respective independent streams of dynamic content are sent in parallel in response to requests from respective scripts running at the client.

4. The method of claim 3 further comprising:
sending the scripts as part of the main web page.

5. The method of claim 3 further comprising:
in the main web page, sending identifiers uniquely identifying respective of the dynamic sections by which the scripts can retrieve dynamic content for a corresponding dynamic section.

6. The method of claim 1 wherein:
dynamic sections within the template are denoted with tags;
locating the dynamic sections within the template comprises encountering the tags; and
the sending of respective independent streams of dynamic content to the client in parallel is performed responsive to encountering at least one of the tags.

7. The method of claim 1 further comprising:
receiving the main web page from the server, wherein the main web page comprises sections corresponding to the dynamic sections within the template and processed in parallel, but the main web page omits dynamic content for the dynamic sections within the template;
receiving content for respective of the dynamic sections within the template; and
displaying content for respective of the dynamic sections within the main web page in parallel in a browser.

8. The computer-implemented method of claim 7 wherein:
the sections processed in parallel are processed in parallel at the server as a result of being denoted in the template with tags processed by a template engine configured to process the sections in parallel responsive to encountering the tags.

9. The computer-implemented method of claim 9 wherein:
the template comprises a JavaServer page;
dynamic sections within the template are received from Java code executing at the server; and
a plurality of scripts execute in parallel at the client to retrieve dynamic content for respective dynamic sections of the main web page.

10. The computer-implemented method of claim 9 further comprising:
receiving the plurality of scripts as part of the main web page.

11. The computer-implemented method of claim 9 further comprising:
in the main web page, receiving identifier uniquely identifying respective of the dynamic sections by which the scripts can retrieve dynamic content for a corresponding dynamic section from the server.

12. A computer-implemented method of processing a web page derived from a template comprising a plurality of dynamic sections, the method comprising:
receiving a main web page from a server, wherein the main web page comprises sections corresponding to the dynamic sections within the template and processed in parallel, but omits content for the dynamic sections within the template;
receiving content for respective of the dynamic sections within the template; and
displaying content for respective of the dynamic sections within the web page in parallel in a browser.

13. The computer-implemented method of claim 12 wherein:
the sections processed in parallel are processed in parallel at the server as a result of being denoted in the template with tags processed by a template engine configured to process the sections in parallel responsive to encountering the tags.

14. The computer-implemented method of claim 12 wherein:
the template comprises a JavaServer page;
dynamic sections within the template are received from Java code executing at a server; and
a plurality of scripts execute in parallel at the client to retrieve dynamic content for respective dynamic sections of the main web page.

15. The computer-implemented method of claim 14 further comprising:
receiving the plurality of scripts as part of the main web page.

16. The computer-implemented method of claim 14 further comprising:
in the main web page, receiving identifier uniquely identifying respective of the dynamic sections by which the scripts can retrieve dynamic content for a corresponding dynamic section from the server.

17. A general-purpose computer configured to perform a method of processing a web page template comprising a plurality of dynamic sections, the general purpose computer comprising:
a programming module configured for processing the web page template at a server, wherein the processing comprises locating the dynamic sections within the template;
a programming module configured for sending a main web page to a client, wherein the main web page omits content for the dynamic sections within the template; and
a programming module configured for, sending respective independent streams of dynamic for content dynamic sections within the template to the client in parallel for display by the client within the main web page.

18. One or more computer-readable storage media comprising computer-executable instructions causing a computer to perform a method comprising:
responsive to an HTTP request for a web page represented by a JavaServer Page, processing the JavaServer Page, wherein the processing comprises background parallel processing by a servlet container of dynamic sections within the JavaServer Page designated by a special tag;
recognizing the special tag in a template engine processing the template, wherein the recognizing triggers parallel processing and streaming of dynamic content for the dynamic sections;
forming content of a main web page without sections marked by the special tag;
placing placeholders with a section identifier uniquely identifying the section within the web page;
placing scripts within respective of the placeholders in the main web page for execution at the client, wherein the scripts are configured to make requests in parallel to the servlet container with the section identifier;
sending the main web page to the client for display in a browser; and
responsive to requests from the scripts, sending dynamic content for respective of the dynamic sections of the web page.
